(19) United States
(12) Patent Application Publication
(10) Pub. No.: US 2025/0332499 A1
(43) Pub. Date: Oct. 30, 2025

(54) All-In-One Ski and Snowboard Accessory Tool

(71) Applicant: Randolph Kemps, Redwood City, CA (US)

(72) Inventors: Randolph Kemps, Redwood City, CA (US); Hermann Kronbauer, Aschheim (DE)

(21) Appl. No.: 19/209,856

(22) Filed: May 16, 2025

Related U.S. Application Data
(63) Continuation of application No. 18/422,633, filed on Jan. 25, 2024, now abandoned.

(51) Int. Cl. A63C 11/14; A63B 29/02; F21L 4/02; F21V 33/00; F21W 111/10; F21Y 101/00; F21Y 115/10

(52) U.S. Cl. CPC A63C 11/14; A63B 29/021; F21L 4/027; F21V 33/0076; F21V 33/0084; F21W 2111/10; F21Y 2101/00; F21Y 2115/10

(57) ABSTRACT

Disclosed in the present invention is an all-in-one ski and snowboard accessory tool as a comprehensive repair and maintenance tool set for skiers and snowboarders and other winter sports athletes. The accessory combines both physical tools and electronics in a compact and lightweight form that allows the skier or snowboarder to maintain, adjust and repair their equipment as needed. This compact accessory provides the tools to file down the edges to the desired gradient for a smoother experience and better performance. Tools to adjust bindings are also included. An avalanche transmitter as well as a LED light for emergency situations are integrated into the accessory for improved safety in dangerous situations. During use, the edges of skis or snowboards can change their gradients and become irregular. Bindings may need to be adjusted. The compact form allows the athlete to carry the accessory in normal ski gear.

### CROSS REFERENCE TO RELATED APPLICATIONS

The present application is a Continuation-In-Part application of U.S. patent application Ser. No. 18/422,633, filed on Jan. 25, 2024, entitled “All-in-One Ski and Snowboard Accessory Tool,” which is herein incorporated in its entirety.

### TECHNICAL FIELD OF INVENTION

The present invention relates to mechanical and electronic tools, and more specifically, to the all-in-one ski and snowboard accessory tool as a comprehensive repair and maintenance tool set with a combination of mechanics and electronics for skiers and snowboarders and other winter sports athletes.

### BACKGROUND OF THE INVENTION

Snowboarding was created in 1965 when an engineer from Michigan named Sherman Poppen invented the prototype of a snowboard. (Of course, like many inventions, others claim they invented the first snowboard—more on this later.) Poppen's initial prototype was a simple design: two skis that were cross-braced together. Skiing is the art or sport of sliding and jumping on skis. Skiing is a sport that makes use of a pair of skis for traveling on snow. Snowboarding is a sport where the participant descends a snowy slope with a single snowboard attached to his feet. Equipment (Number of boards) 2—A pair of skis appended to boots by way of binding.

The U.S. Pat. No. 6,631,918B2 of 2000 discloses a gliding board, such as a ski, and a gliding board equipped with a boot-retaining assembly. It comprises an alpine including a longitudinal beam having front and rear ends and a central zone, the beam being formed by a main core covering a running surface, a stack of gliding and reinforcing layers with two lateral running edges, the core itself being covered by a stack of reinforcing, and possibly decorating layers. In the central zone, a secondary core is superposed on the main core so as to form, in this central zone, a projecting rib having a reduced width. An interface with a plate for supporting the retaining elements is provided to be assembled to the ski by journals.

However, the above art does not describe the all-in-one ski and snowboard accessory tool being proposed in the present invention.

Further, there is no tool on the market that meets the extensive maintenance and repair requirements for winter sports of skiing and snowboarding. There is also no tool that incorporates the electronics of an avalanche transmitter and LED flashlight as well as mechanical tools into a combined accessory.

All of the tools offered in the market today are inadequate due to their limited problem-solving capabilities:
Some are only offered as a screwing tool, sometimes with unnecessary scope.
Some tools are only available as a steel edge sharpener.
Many products are too bulky as a carrying tool set and must be carried in a backpack.
There is a risk of injury if carried in standard sports clothing because of their weight, shape and bulk or in an external pack such as a backpack.
There is no sensible way to combine the individual products without a backpack or special containers.
The skier or snowboarder is forced to take too many unnecessary tools, carry unnecessary weight and unnecessary bulk.
There is no known accessory for skiers. snowboarders and other winter sports athletes that combine tools and electronics for emergency situations.

There is therefore a need for appropriate tools for maintenance, repair and offering immediate help in an emergency for athletes at all competitive levels, ensuring safety and independence. The same set of tools can also be used for maintenance to improve performance. The inclusion of electronics for location detection through an avalanche transmitter and a LED flashlight make for an indispensable safety accessory.

Skiers and Snowboarders, whether enthusiasts or competitive, need to plan and prepare for emergencies, malfunctions or mishaps. Equipment may need to be repaired, adjusted or maintained to offer optimal sporting performance of their skis and snowboards.

Several tools for fixing such individual problems exist on the market today. But to be prepared for most eventualities, skiers and snowboarders must carry a variety of tools contributing to bulk and weight.

### OBJECTS OF THE INVENTION

The main object of the present invention is to provide an all-in-one ski and snowboard accessory tool that is compact and lightweight and which eliminates the need for a mix of tools that possibly add to weight and bulk when carried on the person or in a carrier such as a backpack and thus hinder performance.

Another object of the present invention is to avail safety features such as an avalanche transmitter and LED light make this a vital and unique accessory skiing and snowboarding.

Another object of the present invention is to avail an all-in-one ski and snowboard accessory tool that eliminates the need for several tools from different manufacturers to repair many of the common issues skiers and snowboarders face during time on a slope.

The following summary is an explanation of some of the general inventive steps for the system, method, architecture and container in the description.

### SUMMARY OF THE INVENTION

The present invention describes an all-in-one ski and snowboard accessory tool as a comprehensive repair and maintenance tool set with a combination of mechanics and electronics for skiers and snowboarders and other winter sports athletes.

In one embodiment, the all-in-one ski and snowboard accessory tool eliminates the need for several tools from different manufacturers to repair many of the common issues skiers and snowboarders face during time on a slope.

In a second embodiment, the invention offers a compact and lightweight accessory, the tools required to fix bindings or tune ski edges, and other common problems are contained in a small device that is also ideal for maintenance.

In a third embodiment, the invention describes an accessory that is low weight and small size and which allows easy transportation in winter sports clothing.

Yet in a fourth embodiment, the present invention describes an accessory that is also configured with the electronics of an avalanche transmitter and LED flashlight.

The above summary is not an extensive overview of the invention and does not intend to limit the scope beyond what is described and claimed as a summary.

### BRIEF DESCRIPTION OF DRAWINGS

The novel features believed to be characteristic of the illustrative embodiments are outlined in the appended claims. The illustrative embodiments, however, as well as a preferred mode of use, further objectives, and descriptions thereof, will best be understood by reference to the following detailed description of one or more illustrative embodiments of the present disclosure when read in conjunction with the accompanying drawings.

FIG. 1A is a representation of an all-in-one ski and snowboard accessory tool showing a tool with a transmitter & LED flashlight and base case as described in the present invention.

FIG. 1B is a representation of an all-in-one ski and snowboard accessory tool showing a tool with transmitter & LED flashlight and transmitter house as described in the present invention.

FIG. 1C is a representation of an all-in-one ski and snowboard accessory tool showing a tool with transmitter & LED flashlight and battery as described in the present invention.

FIG. 2A is a representation of an all-in-one ski and snowboard accessory tool to show the base and transmitter housing as described in the present invention.

FIG. 2B is a representation of an all-in-one ski and snowboard accessory tool to show the base and transmitter housing as described in the present invention.

FIG. 3 is a representation of an all-in-one ski and snowboard accessory tool with a control LED as described in the present invention.

FIG. 4 is a representation of an all-in-one ski and snowboard accessory tool depicting a flashlight/signal LED on/off as described in the present invention.

FIG. 5A is a representation of an all-in-one ski and snowboard accessory tool with a file as described in the present invention.

FIG. 5B is a representation of an all-in-one ski and snowboard accessory tool with insert skids as described in the present invention.

FIG. 5C is a representation of an all-in-one ski and snowboard accessory tool with insert skids as described in the present invention.

FIG. 6 is a representation of an all-in-one ski and snowboard accessory tool with miscellaneous bits as described in the present invention.

FIG. 7 is a representation of a dismantled all-in-one ski and snowboard accessory tool showing a backstop among other parts as described in the present invention.

FIG. 8 is a representation of an all-in-one ski and snowboard accessory tool the electronic part as described in the present invention.

FIG. 9 is a representation of an all-in-one ski and snowboard accessory tool the control LED as described in the present invention.

The above figures describe the components contained in the accessory, their layout, and their location. The drawings identify the various tools and also the location of the avalanche transmitter and LED flashlight. These drawings depict the complete standard accessory, including the transmitter and battery sections. Customization of the tool set to an equipment-specific model is possible.

### DETAILED DESCRIPTION OF INVENTION

In the following detailed description of the invention, numerous details, examples, and embodiments of the invention are described. However, it will be clear and apparent to those knowledgeable in the field that the invention is not limited to the embodiments set forth and that the invention can be adapted for a wider range of applications.

In this description, the terms “comprising,” “including,” “containing,” “characterized by,” and grammatical equivalents thereof are inclusive or open-ended terms that do not exclude additional, un-recited elements or method acts, but also include the more restrictive terms “consisting of” and “consisting essentially of” and grammatical equivalents thereof. As used herein, the term “may” with respect to a material, structure, feature or method act indicates that such is contemplated for use in implementation of an embodiment of the disclosure and such term is used in preference to the more restrictive term “is” so as to avoid any implication that other, compatible materials, structures, features and methods usable in combination therewith should or must be, excluded.

The singular forms “a,” “an,” and “the” are intended to include the plural forms as well, unless the context clearly indicates otherwise.

The term “and/or” includes any and all combinations of one or more of the associated listed items. As used herein, relational terms, such as “first,” “second,” “top,” “bottom,” “upper,” “lower,” “over,” “under,” etc., are used for clarity and convenience in understanding the disclosure and do not connote or depend on any specific preference, orientation, or order, except where the context clearly indicates otherwise.

Based on the current offerings of tools for skiers and snowboarders and other winter sports athletes on the market there is a need for a collection of essential tools in a single compact unit that offer immediate help for ski and snowboard athletes at all competitive levels in an emergency. Maintenance of equipment before activity ensures better performance, safety and independence.

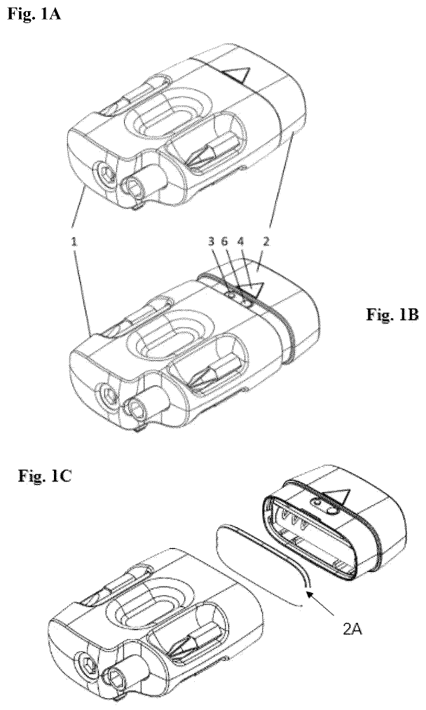

Turning to the drawings, FIG. 1A is a representation of an all-in-one ski and snowboard accessory tool showing a tool with a transmitter & LED flashlight and base case (1). The all-in-one ski & snowboard tool with transmitter (6) & LED flashlight (5) and all in one ski & snowboarding accessory tool parts are firmly locked together into one combined accessory unit. In FIG. 1B, the invention presents an all-in-one ski and snowboard accessory tool showing a tool with transmitter (6) & LED flashlight (5) and transmitter housing (2). To switch on the avalanche beacon on/off, the housing (2) is pushed up to a locking point of approx. 5 mm. The button (6) is protected when both housing parts are firmly connected again.

The LED Flashlight (5) is contained in the unit. In FIG. 1C, the invention presents an all-in-one ski and snowboard accessory tool showing a protective cover 2A. To change the battery (14), housing (2) can be completely separated from housing (2). The protective cover can be removed, and the battery (14) replaced. This type of structure or combination allows more opportunities to expand the flexibility of the accessory. The invention generally offers the tool with an avalanche beacon and LED Flashlight (4).

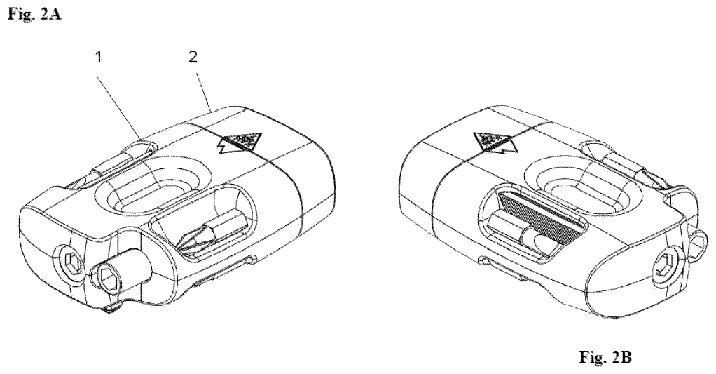

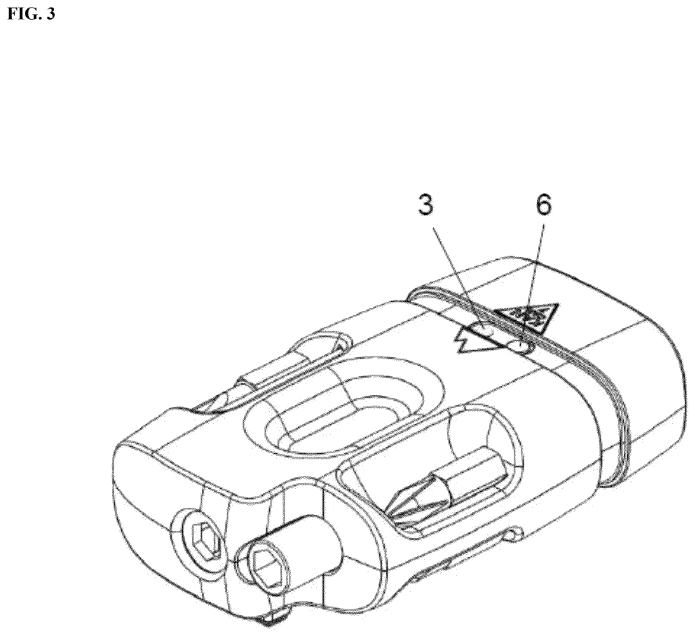

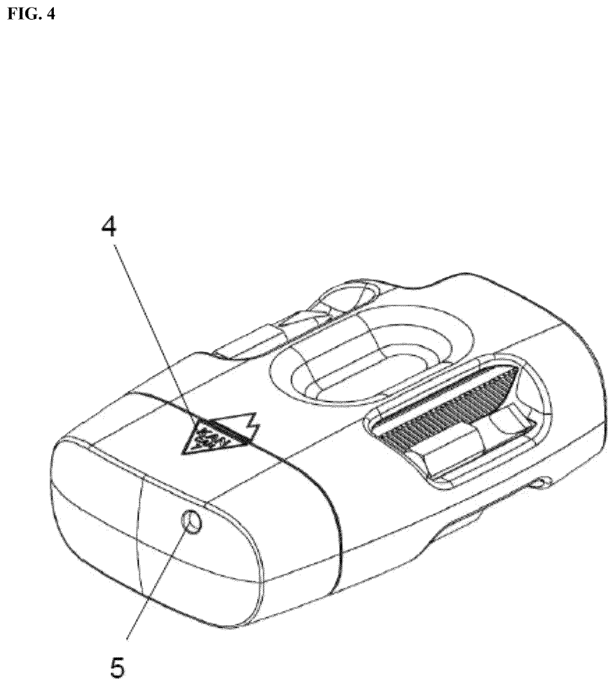

In FIG. 2A, the invention presents an all-in-one ski and snowboard accessory tool to show the base case (1) and transmitter housing (2) as described in the present invention. In FIG. 2B, the invention presents an all-in-one ski and snowboard accessory tool to show the base and transmitter housing (2) as described in the present invention. In FIG. 3, the invention presents an all-in-one ski and snowboard accessory tool with a control LED (3) and a transmitter on/off (6). In FIG. 4, the invention presents an all-in-one ski and snowboard accessory tool depicting a flashlight/signal LED on/off (4), and LED lamp for signals (5).

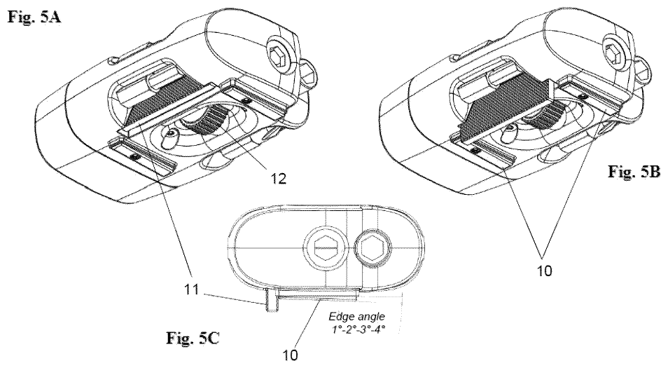

In FIG. 5A, the invention presents an all-in-one ski and snowboard accessory tool with a file (11), thumb wheel (12) for clamping the file (11). In FIG. 5B, the invention presents an all-in-one ski and snowboard accessory tool with insert skids (10). In FIG. 5C, the invention presents an all-in-one ski and snowboard accessory tool with insert skids (10). To change the battery (14), housing (B) can be completely separated from housing (A). The protective cover can be removed, and the battery (14) replaced.

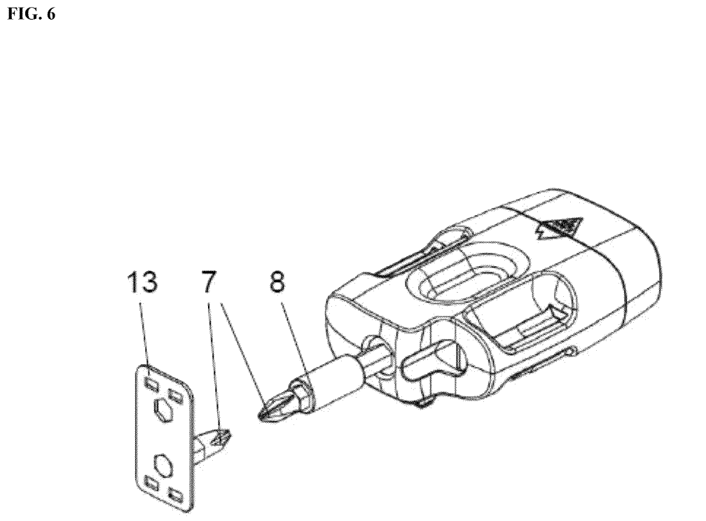

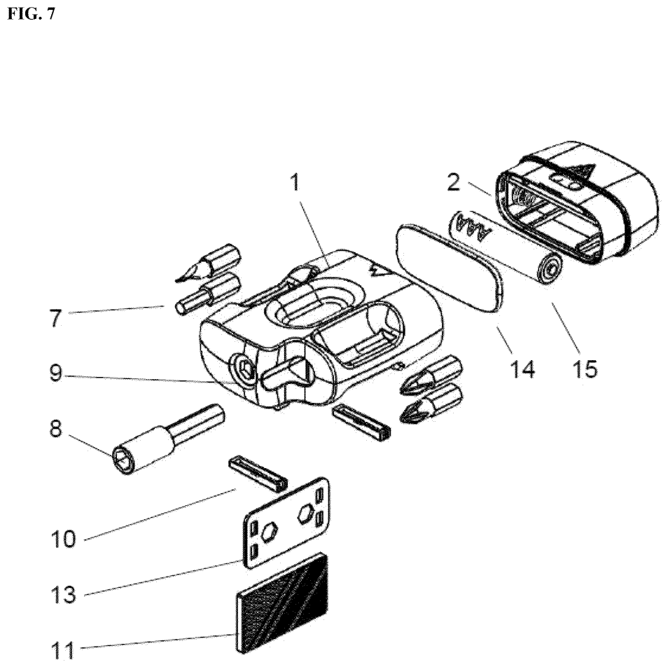

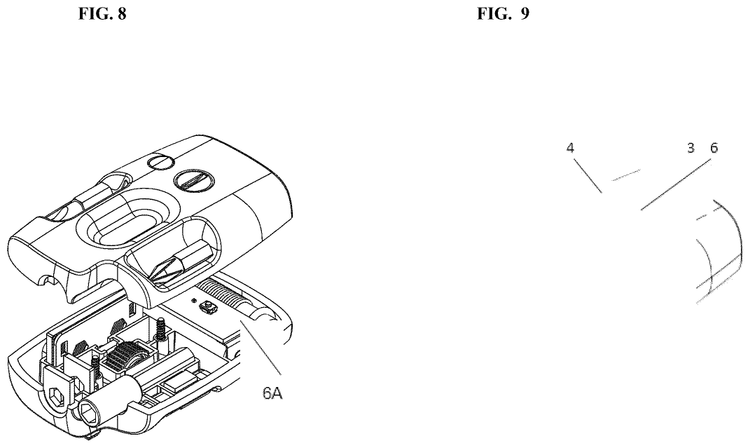

In FIG. 6, the invention presents an all-in-one ski and snowboard accessory tool with miscellaneous bits (7), bit extension (8) and backstop (13). In FIG. 7, the invention presents a dismantled all-in-one ski and snowboard accessory tool showing a base case (1), transmitter housing (2), bit extension (8), bit adapter (9), backstop (13), insert skids (10), battery cover (14), battery (15) and file (11) among other parts. In FIG. 8, the invention presents an all-in-one ski and snowboard accessory tool the electronic part (6A) wherein the electronic part has an avalanche Transmitter (6) with Flashlight-Button (4) and battery (14). In FIG. 9, the invention presents an all-in-one ski and snowboard accessory the control LED (3), combined with the button on/off fixed to a transmitter (6). Transparent button

The requirements for a tool that offers the user these advantages are realized in the All-In-One Accessory Tool.

### Ski & Snowboard Accessory Tool

All required screwing tools are contained in the housing (2).
The type of screwing tools can be changed according to individual requirements (device specific), thus eliminating the need to take unnecessary tools.
The housing (2) is used as a screwdriver handle.
Slidable and clampable in the housing is a file (11) of standard size. This file can be replaced with files of different degrees of fineness.
The file (11) is slotted into the housing after use and secured by clamping.
By replacing the skids (10) for filing the steel edges, different grinding angles can be created.
An avalanche transmitter (6) is housed in a separate section (transmitter on/off) and removeable (for a battery change) housing part which transmits in an emergency at the internationally common frequency of 457 kHz. A LED light with SOS signal capability is included.
The small and compact housing can be stored in any sports clothing pocket without the risk of injury.

An avalanche transmitter (6) is integrated into the unit. The transmitter can be located by all worldwide standard avalanche search devices at a frequency of 457 kHz. A light-emitting diode is also integrated and used as a flashlight (4) or to send emergency signals (SOS).

The unit contains the tools required to maintain, repair and fix common problems during use of skis or snowboards. It is also the perfect accessory in an emergency. The unit is compact with low weight making it an ideal accessory for active snow sport athletes, skiers and snowboarders, at all levels of performance. The accessory tool fits into regular winter sports clothing without adding to bulk. The size and shape ensure there is no danger to the athlete during a fall.

The All-In-One Ski & Snowboard Accessory Tool is a combination tool for use during ski or snowboard activity for grinding the steel edges of snowboards and skis to the desired angle, for smoothing out damage to the steel edges, for changing the gradient of the steel edges, and as a tool for tightening, securing and adjusting screw connections and Ski and snowboard bindings that have become loose during use.

The comprehensive set of tools allows the skier or snowboarder to be prepared for most eventualities. This valuable accessory avoids the need for skiers or snowboarders to carry a variety of tools that may be bulky and heavier. Using this tool allows quick and easy repairs and safely tools in an emergency. The avalanche transmitter and LED light (5) offer additional safety features.

During transportation, the two housing shells are secured by centering to each other with hook latches so that the contents cannot be displaced from their location or lost. There is no risk of injury in the event of a fall.

### Mode of Operation of Invention

The novelty of this invention lies in the combination of several indispensable and practical tools in one compact and lightweight housing that can fix many of the most common problems encountered by winter sports athletes during activity on the slopes. It is an essential safety tool through the avalanche transmitter (6) and flashlight (4). It also serves as a tool kit for routine maintenance. The inclusion of an avalanche transmitter (6) and LED flashlight (4) optionally make this accessory unique and practical. No other accessory on the market combines electronics and physical tools.

In one embodiment, the present presents an all-in-one ski and snowboard accessory tool as a comprehensive repair and maintenance tool set with a combination of mechanics and electronics for skiers and snowboarders and other winter sports athletes. All the mechanical and electronic parts required for the functions are integrated in one unit made of plastic or metal, which serves both as a handle for the tuning function and as a handle for the screwing functions (as a handle in housing FIG. 1A with housing FIG. 1B). The device also contains an integrated avalanche transmitter with two locking positions, removable for a battery change.

In another embodiment according to FIG. 8 and FIG. 9, the present invention presents an electronic part may also be integrated in the main housing rather than in a distinct removable chamber. The device also contains an integrated LED flashlight (4). This electronic part may also be integrated in the main housing rather than in a distinct removable chamber (FIG. 8 and FIG. 9).

The number and type of mechanical parts, screwdriver bits, bit extensions, and file (11) with mechanical clamping, bit adapter, and similar can be customized and located in the basic housing as parts can be replaced with equipment-specific parts. The bit adapter (9) for bits and bit extension in the body is designed as a ratchet. The combination tool can be used as a screwdriver where the screwdriver bits (7) can be fitted directly into the bit adapter (9), or in a bit extension (8), which in turn has been inserted into the bit adapter (9).

In another embodiment, the invention illustrates a file (11) remains secured in the housing pocket provided for this purpose with the clamping screw and knurled wheel (12) during the screw-driving operation, as in the transport position.

During use as a tuning tool, the file (11) is extracted by loosening the clamping screw with the knurled wheel (12) and brought to a working position. It is secured by clamping or pressing on the housing (1). Use the combination tool for tuning, applying the file (11) to the steel edge of the ski or snowboard to achieve the desired angle. The All-In-One Ski tool allows up to four angles. by changing the runners. The file of the combination tool can be used to break sharp ski steel edges. The avalanche transmitter, in housing (2), can be moved to protect the on/off button (6). A LED light (3) is used for checking the battery status and the transmitter on/off function, and a button (4) for actuating the LED (5) is equipped for lighting and emergency signals.

### Advantages

The present invention describes an all-in-one ski and snowboard accessory tool as a comprehensive repair and maintenance tool set with a combination of mechanics and electronics. The tools inside can be customized to specific ski or snowboard equipment models or brands. The device can be used during an emergency and also for regular tuning and maintenance. One of the tools can be used for tuning the steel edges of snowboards and skis to the desired angle, smoothing out damage to the steel edges and changing the gradient of the steel edges. Other tools in the accessory can be used for tightening, securing and adjusting screw connections and ski and snowboard bindings that have become loose during use.

While the invention has been described with reference to numerous specific sensors, one of ordinary knowledge in the field will recognize that the invention can be embodied in other specific forms without departing from the spirit of the invention. Specific operations may not be performed in one continuous series of operations, and different specific operations may be performed in different embodiments. Furthermore, the processes or methods could be implemented using several sub-processes, or as part of a larger macro process. Thus, one of ordinary knowledge in the field would understand that the invention is not to be limited by the foregoing illustrative details, but rather is to be defined by the appended claims.

### INDUSTRIAL APPLICATION

The present invention applies to mechanical and electronic tools. It brings to the market an all-in-one ski and snowboard accessory tool as a comprehensive repair and maintenance tool set with a combination of mechanics and electronics for skiers and snowboarders and other winter sports athletes. An accessory that is designed to eliminate the need for several tools from different manufacturers to repair many of the common issues skiers and snowboarders face during time on a slope. Another important benefit of the provision of compact and lightweight accessory, the tools required to fix bindings or tune ski edges, and other common problems are contained in a small device that is also ideal for maintenance. The other benefits of this tool are its low weight and small size which allows easy transportation in winter sports clothing. This accessory is also configured with the electronics of an avalanche transmitter and LED flashlight.

What is claimed is:

1. An all-in-one ski and snowboard accessory tool designed as a comprehensive repair and maintenance tool set for skiers and snowboarders and other winter sports athletes, comprising:
a. mechanical components,
b. electronics components, and
c. a housing configured to integrate or removably contain the mechanical and electronic parts required for the function into one accessory unit.

2. The all-in-one ski and snowboard accessory tool according to claim 1, wherein all the mechanical and electronic parts are contained in a housing which serves both as a handle for the tuning function and as a handle for the screwing functions.

3. The all-in-one ski and snowboard accessory tool according to claim 1, wherein the electronic part further comprises an integrated avalanche transmitter with two locking positions, removable for a battery change integrated in the main housing.

4. The all-in-one ski and snowboard accessory tool according to claim 3, wherein the electronic part further contains an integrated LED flashlight and button (4).

5. The all-in-one ski and snowboard accessory tool according to claim 4, wherein the LED light (3) is used for checking the battery status and the transmitter on/off function.

6. The all-in-one ski and snowboard accessory tool according to claim 4, wherein the button (4) is crafted for actuating the LED (5) that is equipped for lighting and emergency signals.

7. The all-in-one ski and snowboard accessory tool according to claim 1, wherein the electronic part may be a distinct removable chamber.

8. The all-in-one ski and snowboard accessory tool according to claim 1, wherein the unit further comprises:
a. a plurality of mechanical parts,
b. screwdriver bits,
c. bit extensions,
d. a file with mechanical clamping,
e. a bit adapter, and
f. interchangeable parts that can be customized and located in the basic housing and replaced with equipment-specific parts.

9. The all-in-one ski and snowboard accessory tool according to claim 8, wherein the bit adapter (9) for bits and bit extension in the body is designed as a ratchet.

10. The all-in-One Ski and Snowboard Accessory tool according to claim 8, wherein the combination tool can be used as a screwdriver wherein the screwdriver bits (7) can be fitted directly into the bit adapter (9), or in a bit extension (8), which in turn has been inserted into the bit adapter (9).

11. The all-in-one ski and snowboard accessory tool according to claim 1, further comprising:
a. a file (11) that remains secured in the housing pocket provided for this purpose
b. a clamping screw, and
c. a knurled wheel (12)
wherein the file remains secured during the screw-driving operation and in the transport position.

12. The all-in-one ski and snowboard accessory tool according to claim 11, wherein for use as a tuning tool, the file (11) is extracted by loosening the clamping screw with the knurled wheel (12) and brought to a working position and secured by clamping or pressing on the housing (1).

13. The all-in-one ski and snowboard accessory tool according to claim 11, wherein the accessory unit is used as a combination tool for tuning, the user is enabled to apply the file (11) to the steel edge of the ski or snowboard to achieve the desired angle, so that the all-in-one ski tool allows up to four angles by changing the runners.

14. The all-in-one ski and snowboard accessory tool according to claim 13, wherein the file of the combination tool can be used by changing the runners and to break sharp ski steel edges.
